(19) United States
(12) Patent Application Publication
(10) Pub. No.: US 2002/0059177 A1
(43) Pub. Date: May 16, 2002

(54) Method of forming a template and associated computer device and computer software program product

(76) Inventor: Paul Hansen, Raleigh, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 09/902,079

(22) Filed: Jul. 10, 2001

Related U.S. Application Data
(60) Provisional application No. 60/269,172, filed on Feb. 15, 2001.
(60) Provisional application No. 60/217,616, filed on Jul. 11, 2000.

(51) Int. Cl. G06F 7/00

(52) U.S. Cl. 707/1

(57) ABSTRACT

A method of forming a template for a countertop is provided, wherein the template is usable to form a countertop configured for application to an existing countertop-receiving structure. First, data is collected with a single portable data collection module and according to a coordinate system established with respect to a countertop-receiving structure, wherein the data comprises a plurality of points directly corresponding to and defining the countertop-receiving structure. The data is then processed so as to form a closed-boundary representation of a countertop corresponding to the countertop-receiving structure. Thereafter, the countertop representation is dimensioned to form a template usable to form the countertop such that the formed countertop is thereby correspondingly engageable with the countertop-receiving structure. An associated method of forming a countertop is provided, as well as an associated computer software program product and computer device.

### CROSS-REFERENCE TO RELATED APPLICATIONS

This application claims the benefit of U.S. Provisional Patent Application No. 60/217,616, filed Jul. 11, 2000 and U.S. Provisional Patent Application No. 60/269,172, filed Feb. 15, 2001, both of which are incorporated herein by reference.

### FIELD OF THE INVENTION

The present invention relates to templating methods and, more particularly, to methods of forming templates with an associated computer device and computer software program product.

### BACKGROUND OF THE INVENTION

A need for a template may be encountered in situations where a product must be dimensioned or manufactured to fit an existing installation structure. For example, a countertop in a kitchen, bath, or other room of a dwelling must be sized according to the cabinet, pedestal, or framework structure which will support the countertop once the countertop is installed. In some instances, the countertop must also be configured to account for soffits, framework, or other features which may be present along an adjacent wall. Where an installation structure already exists, such as at a new construction site with new cabinets or at a remodel site with existing cabinets requiring a replacement countertop, a craftsman (also herein referred to as a “templater”) typically uses large sheets of cardboard or luan (very thin wood) strips and hot glue to create a physical template of the kitchen area to have a countertop.

More particularly, if a countertop installation already exists, the countertop is removed and then used as, or to create, the physical template for the replacement countertop. However, the old countertop may not have been properly and accurately fit to the cabinets or other countertop-receiving structure in its initial installation. As such, using the old countertop to configure the new countertop does not guarantee that new countertop will be properly configured for the installation. In a new installation or where the old countertop is not usable or available, cardboard or luan is often used to form a countertop template. In this process, a straight edge of a piece of cardboard is laid parallel to the front edge of a section of cabinet or other countertop-receiving structure. The cardboard is generally placed so as to hang over the edge of the cabinet by a defined amount, usually 1-¼″, to define a countertop overhang. The overhang is then measured with a tape measure to confirm the correct dimension. The cardboard is thereafter secured to the cabinet with, for example, clamps. If the cabinet is longer than the first piece of cardboard, additional pieces of cardboard are then cut to size and glued to the existing cardboard, again allowing for the correct overhang, until the entire “front” edge of the cabinet structure is covered with a cardboard representation of the desired countertop.

In some instances, the opposing edges of the countertop are adjacent to a wall of the room. However, most of these walls are generally slightly irregular. Thus, the cardboard pieces must be cut to match the actual shape of the wall. Typically, a straightedge is used to check the wall for high and low portions. At the low portions of the wall, additional pieces of cardboard are cut and glued to the existing cardboard shape so as to indicate and compensate for the low portions. Once the cardboard form is completed to define the shape of the countertop, the cardboard form is then marked with notes regarding, for example, where a sink and its associated center line is located, along with other pertinent notes, such as overhang amounts where an overhang is present, where adjacent walls are located, and where the appliances are located. In addition, if the countertop is to include a backsplash, the templater must also create a similar cardboard template covering the area between the top of the base cabinets and the bottom of the upper wall cabinets, while accounting for other features along the wall, such as windows. If accommodations are needs for electrical outlets along the walls, the appropriate holes are generally formed in the physical countertop at the installation site.

Once the physical cardboard template has been created, the countertop may be cut and formed with manual equipment using the dimensions from the template. In some instances, the physical cardboard template is used to generate a blueprint by taking dimensions with a tape measure and then inputting the dimensions into a Computer-Aided Design (CAD) system. If a CNC cutting machine is available, a digitizing option available therewith may allow the machine to generate a 2D profile of the countertop from the template. The 2D profile may subsequently be exported into an associated CAD system for dimensioning the profile, wherein the CNC machine is then programmed to cut the countertop.

However, manual templating of a countertop can be a time-consuming process offering a template which may be no more than a rough estimate of the countertop configuration that is actually required for the installation. Enough cardboard, clamps, and glue for creating the template must be gathered for the particular job, wherein the templater may then need to spend a lot of time piecing the cardboard sections together to form the template. During this process, clamps may slip such that a cardboard section is no longer secured to the cabinets, alignment of the cardboard sections may be approximated or may shift if the glue does not properly set, the cardboard may be torn or distorted, the overhang dimension may only be visually determined or otherwise approximated, or inaccurate cutting of the cardboard may be ignored in favor of later hiding the defect with trimwork or shims. Further, the final template may often be too large to transport to a manufacturing facility, wherein the template must be cut into sections, folded, or partially dismantled for transportation. Also, the cardboard may get wet, torn, or otherwise damaged while being physically transported to the countertop manufacturing facility. Among other issues, the notes written on the template may be illegible or insufficient for conveying the desired message, the template may become lost in shipping, dimensions or locations of features such as the sink may be inaccurately determined from the template. If a complete set of dimensions is not available from the cardboard template, efforts must often be made to revisit the site to complete the manufacturing of the countertop. Still further, the dimensions from the cardboard template may sometimes be inaccurately transferred to an automated manufacturing system, wherein such a mistake may not be realized until the countertop arrives at the site for installation.

Thus, there exists a need for a process for templating a countertop which is time efficient and requires minimal, if any, materials and handling of those materials to form a usable template. Such a process should also be able to accurately account for wall irregularities and features of the installation, such as the sink and electrical outlets, with minimal additional effort. The process should also be capable of retaining the data collected from the installation site for later use or as a backup in case the template is misplaced or damaged. The stored data should also be able to accommodate notes of the templater explaining a particular configuration or providing additional information which may be used to resolve questions or inconsistencies. It would also be desirable for such a process to be compatible with an automated fabrication process at a remote site so as to reduce the risk of damage to the data or template while being transported thereto.

### SUMMARY OF THE INVENTION

The above and other needs are met by the present invention which, in one embodiment, provides a method of forming a template for a countertop, wherein the template is usable to form a countertop configured for application to an existing countertop-receiving structure. First, data is collected with a single portable data collection module and according to a coordinate system established with respect to a countertop-receiving structure, wherein the data comprises a plurality of points directly corresponding to and defining the countertop-receiving structure. The data is then processed so as to form a closed-boundary representation of a countertop corresponding to the countertop-receiving structure. Thereafter, the countertop representation is dimensioned to form a template usable to form the countertop such that the formed countertop is thereby correspondingly engageable with the countertop-receiving structure.

Another advantageous aspect of the present invention comprises a method of forming a countertop, wherein the countertop is configured for application to an existing countertop-receiving structure. First, data is collected with a single portable data collection module and according to a coordinate system established with respect to a countertop-receiving structure, wherein the data comprises a plurality of points directly corresponding to and defining the countertop-receiving structure. The data is then processed so as to form a closed-boundary representation of a countertop corresponding to the countertop-receiving structure. Thereafter, the countertop representation is dimensioned to form a template usable to form the countertop. The countertop is then formed according to the template such that the formed countertop is thereby correspondingly engageable with the countertop-receiving structure.

Yet another advantageous aspect of the present invention comprises a computer software program product executable by a computer device so as to facilitate a process for forming a template. The template is thereafter usable to form a countertop corresponding to an existing countertop-receiving structure. The computer software program product comprises an executable portion capable of directing the collection of data with a single portable data collection module and according to a coordinate system established with respect to a countertop-receiving structure, wherein the data comprises a plurality of points directly corresponding to and defining the countertop-receiving structure. Another executable portion is capable of processing the data so as to form a closed-boundary representation of a countertop corresponding to the countertop-receiving structure. Another executable portion is then capable of dimensioning the countertop representation so as to forming a template usable to form the countertop, wherein the formed countertop is thereby correspondingly engageable with the countertop-receiving structure.

Still another advantageous aspect of the present invention comprises a computer device for facilitating a process for forming a template. The template is thereafter usable to form a countertop corresponding to an existing countertop-receiving structure. The computer device comprises a processing portion for directing the collection of data with a single portable data collection module and according to a coordinate system established with respect to a countertop-receiving structure, wherein the data comprises a plurality of points directly corresponding to and defining the countertop-receiving structure. Another processing portion processes the data so as to form a closed-boundary representation of a countertop corresponding to the countertop-receiving structure. Another processing portion dimensions the countertop representation so as to form a template usable to form the countertop. The formed countertop is thereby correspondingly engageable with the countertop-receiving structure.

Thus, embodiments of the present invention provide a process for templating a countertop which is time efficient and requires minimal, if any, materials and handling of those materials to form a usable template. Such a process is able to accurately account for wall irregularities and other features of the installation, such as the sink and electrical outlets, with minimal additional effort. By collecting the data electronically, the process is capable of retaining the data collected from the installation site for later use or as a backup in case the template is misplaced or damaged. The templater is also able to add notes to the collected data explaining a particular configuration or providing additional information which may be used to resolve questions or inconsistencies. The saved data may be readily configured to be electronically transmitted by, for example, e-mail, to an automated fabrication process at a remote site so as to reduce the risk of damage to the data or template while being transported thereto. In addition, the data is readily adaptable to be compatible with CAD/CAM software and/or directly with a CNC machine for forming the countertop. Thus, embodiments of the present invention provide distinct advantages as discussed further herein.

### BRIEF DESCRIPTION OF THE DRAWINGS

Having thus described the invention in general terms, reference will now be made to the accompanying drawings, which are not necessarily drawn to scale, and wherein:

FIG. 1 is a schematic representation of a templating system configured to form a template of a countertop according to one embodiment of the present invention.

FIGS. 2A-2F are schematic representations of steps of a method for forming a template for a countertop according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

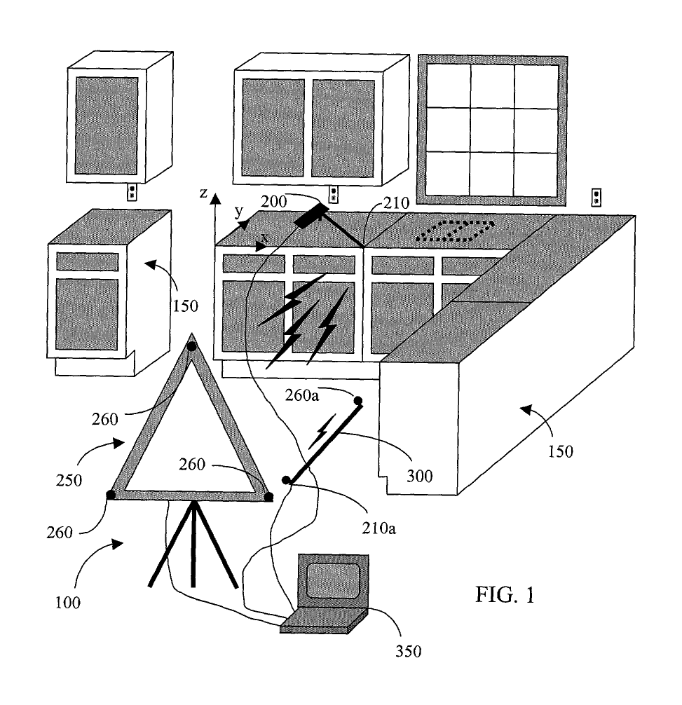

FIG. 1 schematically illustrates a templating system, generally indicated by the numeral 100, being applied so as to form a template for a countertop applicable to a countertop-receiving structure 150. The countertop-receiving structure 150 is also referred to herein as a “cabinet” for convenience, though it is understood that such structures may comprise a wide variety other than just cabinets. The templating system 100 may comprise, for example, a probe 200, a receiver 250, a calibration device 300, and a control module 350. Where the templating system 100 is configured to operate with a sound medium, the system 100 may comprise a “sonic digitizer.” In such an instance, the probe 200 may be handheld and includes one or more sound emitters 210 separated by a known distance and the receiver 250 may comprise a triangular array of sound detecting devices, such as microphones 260, separated by a known distance. Further, the calibration device 300 may comprise, for example, a sound emitter 210a and a microphone 260a separated by a known distance, while the control module 350 may comprise, for example, a computer device, in communication with the probe 200, the receiver 250, and the calibration device 300, wherein such communication may be achieved through, for instance, wireless or wireline provisions. Accordingly, the present invention will be further described herein in exemplary terms of a sonic digitizer.

However, it will be appreciated by one skilled in the art that the system 100, as described, may be configured to operate with a light medium, wherein such a system 100 would comprise, for example, a “laser digitizer.” Accordingly, the probe 200 would include a light emitter and the receiver 250 would comprise an array of photosensitive devices. Still further, the method described herein may be accomplished with other mechanisms such as, for example, an articulating arm digitizer wherein a multi-segment jointed arm replaces the emitter/receiver components of a sound or light system. Accordingly, the rotational angle of each joint and the length of each arm segment are measured, detected, and/or computed to obtain the template. Alternatively, photogrammetry techniques may be utilized, as will also be appreciated by one skilled in the art. In such an instance, one or more digital cameras are used to obtain digital photographs of the structure to be templated, each photograph being taken from a different location with respect to the structure. Each point on the structure is indicated with a marker having a strong contrast with respect to the corresponding background and each point must be in at least two photographs taken from separate camera positions in order to compute and configure the desired template.

As schematically shown in FIG. 1, a sound-based templating system 100 operates by using the speed of sound to measure positions in a three-dimensional space. Therefore, in order to create a countertop template, the positions or coordinates of the countertop-receiving structure 150 may be determined as a basis from which to construct the countertop template. Note also that developing a countertop template from the supporting structure is but one example of the implementation of the present invention. In order to obtain good data to form the template in an existing countertop installation, the countertop generally must be removed from the countertop-receiving structure 150. However, removal of the countertop may not be desirable since the area would not be usable until the replacement countertop is installed. Thus, in some instances, a template may also be determined directly from the existing countertop-receiving structure 150 while the existing countertop remains in place, which allows the existing countertop installation to remain in place until the replacement countertop can be fabricated. In other instances, a template may also be determined directly from an existing countertop having the desired configuration. However, such procedures will not be described further herein since the details thereof will be appreciated by one skilled in the art.

In the configuration shown in FIG. 1, the probe 200 is placed such that the tip thereof engages a desired point on the upper surface of the base cabinet 150. The tip may include, for example, one or more sound emitters 210, wherein, for the purposes of description herein, the probe 200 includes two sound emitters 210 separated by a known distance. Note also that the “points” referred to herein may comprise any locations determined to define the countertop-receiving structure 150. Such points may include a location along an edge, a corner, or any other defined feature which may affect the dimensions and/or shape of the desired countertop. Once the tip of the probe 200 is engaged with a desired point of the cabinet 150, the control module 350 is actuated to simultaneously transmits control signals to the sound emitters 210 on the probe 200 and to the emitter 210a on the calibration device 300. The control signal actuates each emitter to output a sound, or “spark,” at, for example, an ultrasonic frequency. The sounds emitted from the two emitters 210 on the tip of the probe 200 are detected by the three microphones 260 on the triangular array receiver 250. The sound emitted from the emitter 210a on the calibration device 300 is likewise detected by the corresponding microphone 260a on the calibration device 300, wherein the distance between the emitter 210a and microphone 260a of the calibration device 300 is a known fixed length.

Since the calibration device 300 includes an emitter 210a and corresponding microphone 260a separated by a known length, the sound emitted by the emitter 210a should be detected by the microphone 260a in a specific amount of time dictated by the speed of sound. Thus, the difference between the ideal time for detection of the sound and the actual time for detection of the sound may be used to calibrate the other time measurements between the emitters 210 of the probe 200 and the microphones 260 of the receiver 250. Accordingly, the times required for the sounds from the two emitters 210 to be detected by each of the three microphones 260 are measured and, using the speed of sound, translated into a distance measurement. As such, the three distances from one emitter 210 to the respective microphones 260 is used to triangulate to a three dimensional position (x-y-z coordinate) of that emitter 210. Similarly, the three distances from second emitter 210 to the respective microphones 260 is used to triangulate to a three dimensional position (x-y-z coordinate) of the second emitter 210. Thereafter, the position of the tip of the probe 200 is determined from the respective positions of the two emitters 210 and the known distance therebetween.

The concept of a sonic digitizer will be appreciated by one skilled in the art. As such, the operation of such a device will not be further addressed herein. However, one skilled in the art will realize that the functionality of the receiver 250 as described may have limitations as to the distance and orientation of the receiver 250 with respect to the probe 200. As will be described further below, the present invention includes functionality for overcoming such a limitation. The system 100 is configured to determine a reference coordinate system for all of the desired and measured points. Accordingly, a single template may be determined for a single installation, even if the receiver 250 is required to be moved so as to be capable of collecting all of the necessary data for a single countertop-receiving structure 150, by correlating the data from the second site of the receiver 250 with the originally-created reference coordinate system. For example, one or more data points may be collected from corresponding designated features of the countertop-receiving structure 150 at the first site of the receiver 250. After the receiver 250 is moved to a second site, the same data points may again be collected from the designated features of the countertop-receiving structure 150. The data points collected at the second site are then correlated with the corresponding data points collected at the second site to re-establish the reference coordinate system.

According to one practical implementation of the system 100 described herein, the components of the system 100 are first established such that the calibration device 300 is disposed in the general area of the countertop-receiving structure 150 and maintained proximally thereto during the data collection process. Data points are then collected by the control module 350 by actuating the probe 200 when the tip thereof engages a desired point on the countertop-receiving structure 150. Initially, the control module 350 is notified that the desired functionality is the establishment of the reference coordinate system. The reference coordinate system ensures that all collected data may be projected into a single plane so as to facilitate viewing and manipulation of the digitized structure. In one instance, a plurality of points, for example, four points, are collected to generate a ‘best fit’ plane that is established as the Z=0 plane for the collected data, wherein all of the collected data is automatically projected to the z plane. For example, if the countertop-receiving structure 150 comprises cabinets, the four collected points may be collected along the top surface of the cabinets. Accordingly, once the “best fit” reference z plane is determined, further collected data is not required to be at the exact Z=0 level of the reference z plane.

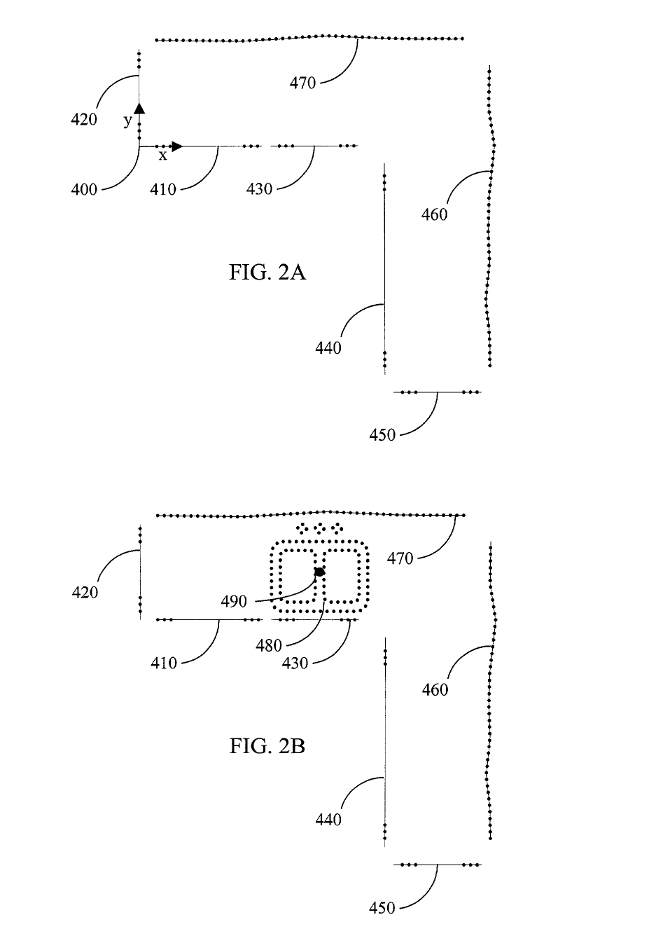

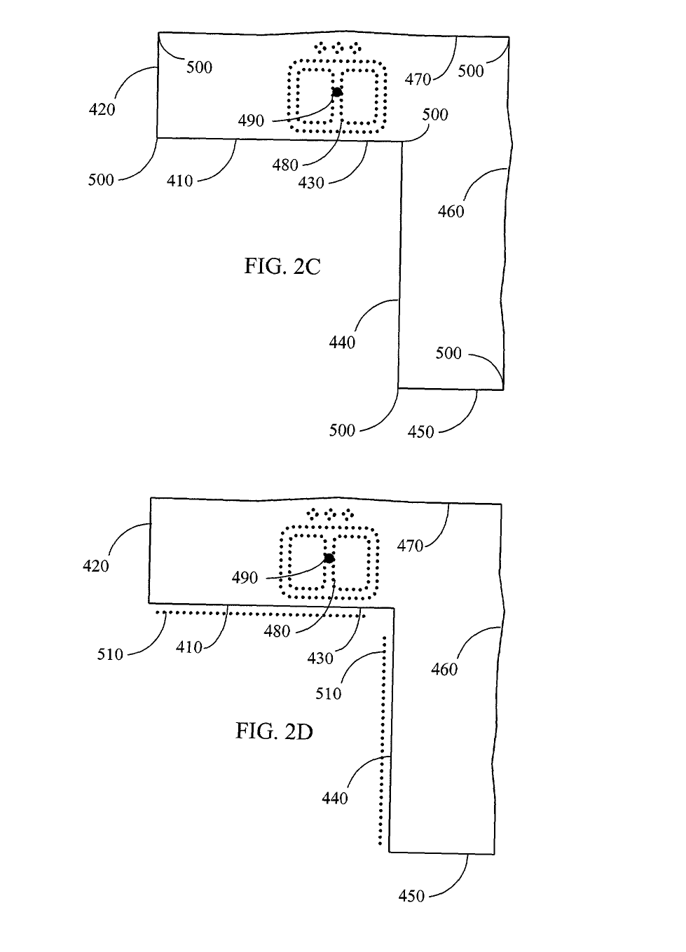

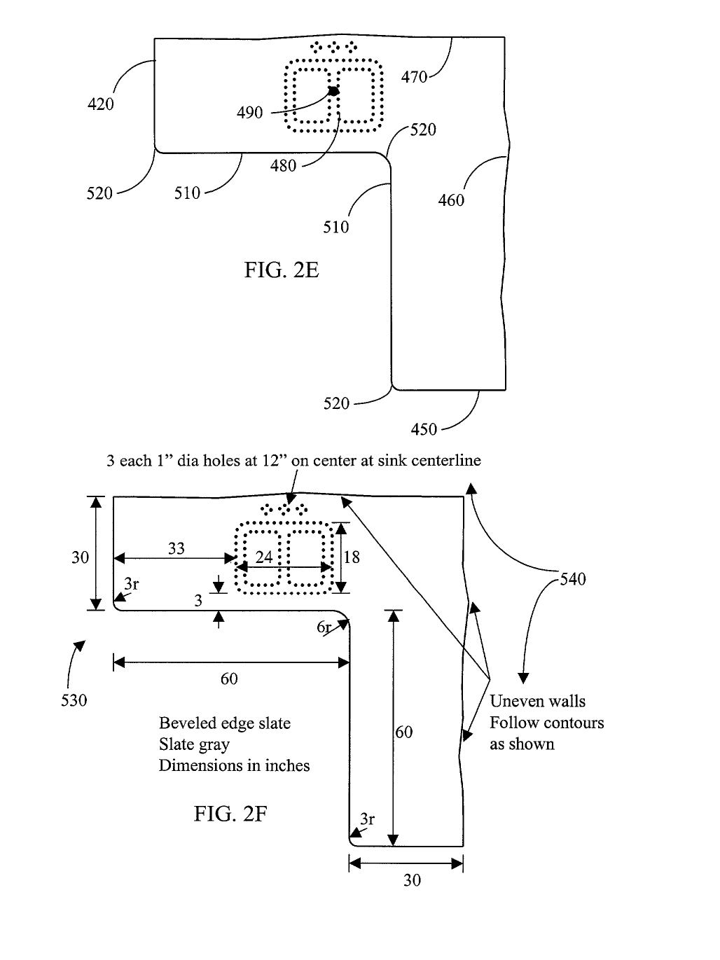

FIGS. 2A-2F schematically illustrate a process of data collection to form the template for the countertop once the z plane has been determined. As shown in FIG. 2A, an origin 400 (X=0, Y=0) of the reference coordinate system is first created at the intersection of two ‘best fit’ lines 410 and 420. Each line 410 and 420 is determined by collecting a plurality of points, for example, three points, at each end of that line. In such an instance, the six points are used to create a best fit line. Once both lines 410 and 420 have been determined, the point of intersection of the lines 410 and 420 is designated as the origin (X=0, Y=0) of the reference coordinate system in the reference z plane. Generally, the positive direction of the x axis corresponds to the direction in which the necessary points defining the x axis are collected by the system 100, whereas the positive direction of the y axis may be defined by a single point relative to the origin.

Once the origin 400 is determined, various other lines 430, 440, and 450 defining the countertop-receiving structure 150 are constructed by collecting data points along the lengths thereof. In order to define a line, the control module 350 is first notified that the desired functionality is the establishment of a line. Each line corresponding to, for example, an edge of the counter-top receiving structure 150, is then collected by actuating the probe 200 as the tip thereof engages, for example, three points at each end of the respective line. Once the six points have been collected, the system 100 automatically creates a ‘best fit’ line through the six points. Note, however, that the number of collected points defining a “line” may vary considerably, though requiring at least two points to define the line, depending on the resolution required for the particular installation. In addition, the number of collected points may also vary, along with the corresponding notification to the control module 350, according to whether the desired line is straight or arcuate.

In instances where a wall adjacent to the countertop-receiving structure 150, or any other member defining the countertop-receiving structure 150, is irregular, the control module 350 is notified that the desired functionality is the establishment of a “spline” or “polyline” corresponding to the irregular scribe for the wall. Though the splines/polylines 460 and 470 shown in FIG. 2A are each defined by many points collected by actuating the probe 200 as the tip thereof engages each point, the number of points collected to define a spline/polyline may vary according to, for example, the resolution required and/or the degree of irregularity of the particular member. In some instances of an irregularly shaped wall, a straight edge may be used to identify the high and low points of the wall. Data points are then collected at each of these defined points. Once the desired number of points are collected for a single wall or other defining member, the control module 350 is notified that the collection of data points therefor has been completed, whereafter the corresponding spline/polyline is created.

As shown in FIG. 2B, in instances where the installation corresponds to a kitchen or bathroom, a sink location 480 may also be a necessary defining feature of the countertop, particularly where sink and/or water pipe installation holes must be cut or otherwise indicated. According to some embodiments of the present invention, a predetermined functionality may be included with the control module 350 whereby, when indicated to the control module 350, only a single data point corresponding to the location of the sink centerline 490 is necessary to define the configuration of the sink and any other associated accessory features. For the purpose of clarity, a number of points defining a sink are shown in addition to the sink centerline point 490.

Once all the raw edges of the countertop-receiving structure 150 have been created, both lines and splines, the intersections of these raw edges must be configured to define respective comers 500, as shown in FIG. 2C. In some instances, the corners 500 are defined as a sharp intersection of the lines though, in other instances, any comer may be defined as an arcuate member, if desired. Generally, the control module 350 is notified that the desired functionality is to “trim” a comer 500. Accordingly, two intersecting raw edges are selected and then the control module 350 is directed to implement the trim function. This process is repeated as necessary until a complete closed two-dimensional profile of the countertop-receiving structure 150 is created. As shown in FIG. 2D, in some instances, it may be desirable for the countertop to include an overhang 510, whereby the countertop is configured to extend past the countertop-receiving structure 150 by a predetermined distance. In such an instance, the control module 350 is notified that the desired functionality is the establishment of an overhang 510. The overhang distance and corresponding defining edge to which an overhang 510 is applied are then selected, whereby the control module 350 then creates the specified overhang 510. As further shown in FIG. 2E, the intersection of overhangs and/or the interaction of an overhang 510 with a defining edge may be configured in many different manners, such as arcuate transitions 520 therebetween. Note also that an overhang 510 may be created by, for example, modifying the countertop-receiving structure 150 with a jig or fixture extending therefrom so as to simulate the overhang 510 and thereafter collecting the necessary data points with the probe 200.

As shown in FIG. 2F, after the completion of the template, as described, the control module 350 may be actuated to perform a dimensioning function, whereby feature-to-feature dimensions, generally indicated by the numeral 530, are determined. Such dimensions may include, for example, the lengths of the edges or a length from an edge to a feature such as the sink centerline 490. Since the template can be created at the installation site, any critical dimensions may then be physically checked with, for example, a tape measure. Additionally, the control module 350 may be actuated to allow the addition of notes, indicated generally by the numeral 540, to the template. Such notes 540 may be necessary to, for example, complete the description of the installation, clarify certain features of the template, or provide any information specific to the particular installation. The notes 540 may also include arrows or other graphic descriptors necessary to indicate the applicability of the respective note.

Once the template has been completed in electronic form, the corresponding data may be manipulated in many different forms. For example, the template may be configured to facilitate the preparation of a materials list. In other instances, the template data may comprise electronic files which may be transmitted over an electronic data communication link, such as, for example, over an on-site network, by e-mail, or via the Internet. Still further, the template data may be configured so as to be compatible with CAD/CAM software for additional manipulation or blueprinting, whereby the template data may then be exported or applied to a CNC machine to facilitate automated fabrication of the corresponding countertop. If desired, the template may also be plotted on paper as a physical template.

It is further contemplated by the present invention that the described system 100 may be applied to create a backsplash for the countertop, wherein the backsplash would merely comprise a “vertical countertop.” In such an instance, a procedure similar to that described may be followed to define the backsplash, in addition to any electrical outlets, windows, or other features of the corresponding wall, in an electronic template. The backsplash may then be manufactured according to the template for a corresponding fit.

Note that, while an example of a templating method for countertops is presented herein for illustration of the present invention, it will be understood that the present invention may be applicable to many other situations involving the determination of a configuration of an item such that the item accurately fits an existing installation structure. For example, the present invention may be used to form a template or specifications for such other items as cabinets to be installed in a room, shelves for a built-in shelf installation, flooring for a room or other application within a building, stones for stonework, the layout of planking for a deck structure or bricks for a patio structure, inlays for inlay work, moldings or other trim, or the like. Note also that the present invention may also be used to duplicate the dimensions of an item that is already installed, but which is targeted for replacement in, for instance, a remodeling or renovation. For example, in a renovation project, the same configuration of an existing countertop may be desired, but in a different color, texture, or material.

Thus, embodiments of the present invention provide a process for templating a countertop which is time efficient and requires minimal, if any, materials and handling of those materials to form a usable template. Such a process is able to accurately account for wall irregularities and other features of the installation, such as the sink and electrical outlets, with minimal additional effort. By collecting the data electronically, the process is capable of retaining the data collected from the installation site for later use or as a backup in case the template is misplaced or damaged. The templater is also able to add notes to the collected data explaining a particular configuration or providing additional information which may be used to resolve questions or inconsistencies. The saved data may be readily configured to be electronically transmitted by, for example, e-mail, to an automated fabrication process at a remote site so as to reduce the risk of damage to the data or template while being transported thereto. In addition, the data is readily adaptable to be compatible with CAD/CAM software and/or directly with a CNC machine for forming the countertop.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of forming a template for a countertop, the template being usable to form a countertop configured for application to an existing countertop-receiving structure, said method comprising:
collecting data with a single portable data collection module and according to a coordinate system established with respect to a countertop-receiving structure, the data comprising a plurality of points directly corresponding to and defining the countertop-receiving structure;
processing the data so as to form a closed-boundary representation of a countertop corresponding to the countertop-receiving structure; and
dimensioning the countertop representation, the countertop representation forming a template configured so as to be usable to form the countertop, the formed countertop thereby being correspondingly engageable with the countertop-receiving structure.

2. A method according to claim 1 further comprising establishing a base horizontal plane with respect to the countertop-receiving structure so as to establish an origin of a Z-axis.

3. A method according to claim 2 further comprising establishing an X-axis having an origin corresponding to the Z-axis origin, the X-axis extending along the base horizontal plane.

4. A method according to claim 3 further comprising establishing a positive Y-direction with respect to the X-axis origin.

5. A method according to claim 1 wherein collecting data further comprises receiving a signal directly from each of the plurality of points with the data collection module, the data collection module being configured so as to be capable of determining a coordinate of each point with respect to the coordinate system.

6. A method according to claim 5 further comprising disposing a sound emitter at each of the plurality of points wherein the sound emitter is configured to emit a sound signal directly from each point, the sound signal being receivable by the data collection module.

7. A method according to claim 5 further comprising disposing a light emitter at each of the plurality of points wherein the light emitter is configured to emit a light signal directly from each point, the light signal being receivable by the data collection module.

8. A method according to claim 1 wherein collecting data further comprises determining a coordinate of each point with respect to the coordinate system with an articulating arm extending from the data collection module directly to the respective point.

9. A method according to claim 1 wherein collecting data further comprises photogrammetrically determining a coordinate of each point with respect to the coordinate system with a plurality of digital images of each point taken from a plurality of image acquisition locations remotely disposed from the countertop-receiving structure, each point being indicated with a marker disposed directly thereon, the marker being configured to have a sharp contrast with respect to the respective point.

10. A method according to claim 1 wherein processing the data further comprises arranging the plurality of points according to a two-dimensional coordinate system on at least one of a horizontal plane and a vertical plane.

11. A method according to claim 1 wherein processing the data further comprises adding an overhang component to the countertop representation, the overhang component being configured to extend outwardly of the countertop-receiving structure.

12. A method according to claim 1 wherein processing the data further comprises defining an accommodation for an accessory feature on the countertop representation, the accommodation being configured to correspond to the accessory feature upon engagement of the countertop with the countertop-receiving structure.

13. A method according to claim 1 wherein processing the data further comprises adding a backsplash component to the countertop representation, the backsplash component being configured to extend generally perpendicularly to the countertop.

14. A method according to claim 1 wherein dimensioning a countertop representation further comprises adding at least one of a numerical dimension and a note to the countertop representation.

15. A method according to claim 1 further comprising configuring the template to be cooperable with computer-aided design/computer-aided manufacturing (CAD/CAM) computer software following dimensioning of the countertop representation.

16. A method according to claim 1 further comprising configuring the template to be cooperable with a Computer Numerical Control (CNC) machine following dimensioning of the countertop representation.

17. A method according to claim 1 further comprising configuring the template to as to be transmittable over an electronic data communication link following dimensioning of the countertop representation.

18. A method according to claim 1 further comprising forming the countertop according to the template following dimensioning of the countertop representation.

19. A method of forming a countertop, the countertop being configured for application to an existing countertop-receiving structure, said method comprising:
collecting data with a single portable data collection module and according to a coordinate system established with respect to a countertop-receiving structure, the data comprising a plurality of points directly corresponding to and defining the countertop-receiving structure;
processing the data so as to form a closed-boundary representation of a countertop corresponding to the countertop-receiving structure; and
dimensioning the countertop representation, the countertop representation forming a template configured so as to be usable to form the countertop; and
forming the countertop according to the template, the formed countertop thereby being correspondingly engageable with the countertop-receiving structure.

20. A method according to claim 19 further comprising establishing a base horizontal plane with respect to the countertop-receiving structure so as to establish an origin of a Z-axis.

21. A method according to claim 20 further comprising establishing an X-axis having an origin corresponding to the Z-axis origin, the X-axis extending along the base horizontal plane.

22. A method according to claim 21 further comprising establishing a positive Y-direction with respect to the X-axis origin.

23. A method according to claim 19 wherein collecting data further comprises receiving a signal directly from each of the plurality of points with the data collection module, the data collection module being configured so as to be capable of determining a coordinate of each point with respect to the coordinate system.

24. A method according to claim 19 further comprising disposing a sound emitter at each of the plurality of points wherein the sound emitter is configured to emit a sound signal directly from each point, the sound signal being receivable by the data collection module.

25. A method according to claim 19 further comprising disposing a light emitter at each of the plurality of points wherein the light emitter is configured to emit a light signal directly from each point, the light signal being receivable by the data collection module.

26. A method according to claim 19 wherein collecting data further comprises determining a coordinate of each point with respect to the coordinate system with an articulating arm extending from the data collection module directly to the respective point.

27. A method according to claim 19 wherein collecting data further comprises photogrammetrically determining a coordinate of each point with respect to the coordinate system with a plurality of digital images of each point taken from a plurality of image acquisition locations remotely disposed from the countertop-receiving structure, each point being indicated with a marker disposed directly thereon, the marker being configured to have a sharp contrast with respect to the respective point.

28. A method according to claim 19 wherein processing the data further comprises arranging the plurality of points according to a two-dimensional coordinate system on at least one of a horizontal plane and a vertical plane.

29. A method according to claim 19 wherein processing the data further comprises adding an overhang component to the countertop representation, the overhang component being configured to extend outwardly of the countertop-receiving structure.

30. A method according to claim 19 wherein processing the data further comprises defining an accommodation for an accessory feature on the countertop representation, the accommodation being configured to correspond to the accessory feature upon engagement of the countertop with the countertop-receiving structure.

31. A method according to claim 19 wherein processing the data further comprises adding a backsplash component to the countertop representation, the backsplash component being configured to extend generally perpendicularly to the countertop.

32. A method according to claim 19 wherein dimensioning a countertop representation further comprises adding at least one of a numerical dimension and a note to the countertop representation.

33. A method according to claim 19 further comprising configuring the template to be cooperable with computer-aided design/computer-aided manufacturing (CAD/CAM) computer software following dimensioning of the countertop representation.

34. A method according to claim 19 further comprising configuring the template to be cooperable with a Computer Numerical Control (CNC) machine following dimensioning of the countertop representation.

35. A method according to claim 19 wherein forming the countertop further comprises forming the countertop at a location disposed remotely with respect to the countertop-receiving structure.

36. A method according to claim 19 wherein forming the countertop further comprises forming the countertop with a Computer Numerical Control (CNC) machine according to the template.

37. A computer software program product executable by a computer device so as to facilitate a process for forming a template, the template being usable to form a countertop corresponding to an existing countertop-receiving structure, said computer software program product comprising:
an executable portion capable of directing the collection of data with a single portable data collection module and according to a coordinate system established with respect to a countertop-receiving structure, the data comprising a plurality of points directly corresponding to and defining the countertop-receiving structure;
an executable portion capable of processing the data so as to form a closed-boundary representation of a countertop corresponding to the countertop-receiving structure; and
an executable portion capable of dimensioning the countertop representation, the countertop representation forming a template configured so as to be usable to form the countertop, the formed countertop thereby being correspondingly engageable with the countertop-receiving structure.

38. A computer software program product according to claim 37 further comprising an executable portion capable of establishing a base horizontal plane with respect to the countertop-receiving structure so as to establish an origin of a Z-axis.

39. A computer software program product according to claim 38 further comprising an executable portion capable of establishing an X-axis having an origin corresponding to the Z-axis origin, the X-axis extending along the base horizontal plane.

40. A computer software program product according to claim 39 further comprising an executable portion capable of establishing a positive Y-direction with respect to the X-axis origin.

41. A computer software program product according to claim 37 wherein the executable portion capable of collecting data is further capable of directing the data collection module to receive a signal directly from each of the plurality of points.

42. A computer software program product according to claim 41 further comprising an executable portion capable of determining a coordinate of each point with respect to the coordinate system from the respective signal received by the data collection module.

43. A computer software program product according to claim 42 further comprising an executable portion capable of re-establishing the coordinate system upon relocation of the data collection module.

44. A computer software program product according to claim 42 wherein the executable portion capable of collecting data is further capable of directing the data collection module to receive a sound signal from each of the plurality of points, each sound signal being emitted by a sound emitter disposed at the respective point.

45. A computer software program product according to claim 42 wherein the executable portion capable of collecting data is further capable of directing the data collection module to receive a light signal from each of the plurality of points, each light signal being emitted by a light emitter disposed at the respective point.

46. A computer software program product according to claim 37 wherein the executable portion capable of collecting data is further capable of determining a coordinate of each point from a positional signal generated by an articulating arm extending from the data collection module directly to the respective point.

47. A computer software program product according to claim 37 wherein the executable portion capable of collecting data is further capable of photogrammetrically determining a coordinate of each point with respect to the coordinate system from a plurality of digital images of each point taken from a plurality of image acquisition locations remotely disposed from the countertop-receiving structure, each of the plurality of points being indicated with a marker configured to have a sharp contrast to the respective point.

48. A computer software program product according to claim 37 wherein the executable portion capable of processing the data is further capable of arranging the plurality of points according to a two-dimensional coordinate system on at least one of a horizontal plane and a vertical plane.

49. A computer software program product according to claim 37 wherein the executable portion capable of processing the data is further capable of defining a best-fit line between points.

50. A computer software program product according to claim 37 wherein the executable portion capable of processing the data is further capable of defining a freeform line between points.

51. A computer software program product according to claim 37 wherein the executable portion capable of processing the data is further capable of defining a line between points.

52. A computer software program product according to claim 37 wherein the executable portion capable of processing the data is further capable of configuring an intersection of lines, each line being defined by a plurality of points, to facilitate formation of the closed-boundary countertop representation.

53. A computer software program product according to claim 37 wherein the executable portion capable of processing the data is further capable of adding an overhang component to the countertop representation, the overhang component being configured to extend outwardly of the countertop-receiving structure.

54. A computer software program product according to claim 37 wherein the executable portion capable of processing the data is further capable of defining an accommodation for an accessory feature on the countertop representation, the accommodation being configured to correspond to the accessory feature upon engagement of the countertop with the countertop-receiving structure.

55. A computer software program product according to claim 37 wherein the executable portion capable of processing the data is further capable of adding a backsplash component to the countertop representation, the backsplash component being configured to extend generally perpendicularly to the countertop.

56. A computer software program product according to claim 37 wherein the executable portion capable of dimensioning a countertop representation is further capable of adding at least one of a numerical dimension and a note to the countertop representation.

57. A computer software program product according to claim 37 further comprising an executable portion capable of configuring the template to be cooperable with computer-aided design/computer-aided manufacturing (CAD/CAM) computer software.

58. A computer software program product according to claim 37 further comprising an executable portion capable of configuring the template to be cooperable with a Computer Numerical Control (CNC) machine.

59. A computer software program product according to claim 37 further comprising an executable portion capable of configuring the template to as to be transmittable over an electronic data communication link.

60. A computer device for facilitating a process for forming a template, the template being usable to form a countertop corresponding to an existing countertop-receiving structure, said computer device comprising:
a processing portion for directing the collection of data with a single portable data collection module and according to a coordinate system established with respect to a countertop-receiving structure, the data comprising a plurality of points directly corresponding to and defining the countertop-receiving structure;
a processing portion for processing the data so as to form a closed-boundary representation of a countertop corresponding to the countertop-receiving structure; and
a processing portion for dimensioning the countertop representation, the countertop representation forming a template configured so as to be usable to form the countertop, the formed countertop thereby being correspondingly engageable with the countertop-receiving structure.

61. A computer device according to claim 60 further comprising a processing portion for establishing a base horizontal plane with respect to the countertop-receiving structure so as to establish an origin of a Z-axis.

62. A computer device according to claim 61 further comprising a processing portion for establishing an X-axis having an origin corresponding to the Z-axis origin, the X-axis extending along the base horizontal plane.

63. A computer device according to claim 62 further comprising a processing portion for establishing a positive Y-direction with respect to the X-axis origin.

64. A computer device according to claim 60 wherein the processing portion for collecting data is further configured to direct the data collection module to receive a signal directly from each of the plurality of points.

65. A computer device according to claim 64 further comprising a processing portion for determining a coordinate of each point with respect to the coordinate system from the respective signal received by the data collection module.

66. A computer device according to claim 65 further comprising a processing portion for re-establishing the coordinate system upon relocation of the data collection module.

67. A computer device according to claim 65 wherein the processing portion for collecting data is further configured to direct the data collection module to receive a sound signal from each of the plurality of points, each sound signal being emitted by a sound emitter disposed at the respective point.

68. A computer device according to claim 65 wherein the processing portion for collecting data is further configured to direct the data collection module to receive a light signal from each of the plurality of points, each light signal being emitted by a light emitter disposed at the respective point.

69. A computer device according to claim 60 wherein the processing portion for collecting data is further configured to determine a coordinate of each point from a positional signal generated by an articulating arm extending from the data collection module directly to the respective point.

70. A computer device according to claim 60 wherein the processing portion for collecting data is further configured to photogrammetrically determine a coordinate of each point with respect to the coordinate system from a plurality of digital images of each point taken from a plurality of image acquisition locations remotely disposed from the countertop-receiving structure, each of the plurality of points being indicated with a marker configured to have a sharp contrast to the respective point.

71. A computer device according to claim 60 wherein the processing portion for processing the data is further configured to arrange the plurality of points according to a two-dimensional coordinate system on at least one of a horizontal plane and a vertical plane.

72. A computer device according to claim 60 wherein the processing portion for processing the data is further configured to define a best-fit line between points.

73. A computer device according to claim 60 wherein the processing portion for processing the data is further configured to define a free-form line between points.

74. A computer device according to claim 60 wherein the processing portion for processing the data is further configured to define a line between points.

75. A computer device according to claim 60 wherein the processing portion for processing the data is further configured to configure an intersection of lines, each line being defined by a plurality of points, to facilitate formation of the closed-boundary countertop representation.

76. A computer device according to claim 60 wherein the processing portion for processing the data is further configured to add an overhang component to the countertop representation, the overhang component being configured to extend outwardly of the countertop-receiving structure.

77. A computer device according to claim 60 wherein the processing portion for processing the data is further configured to define an accommodation for an accessory feature on the countertop representation, the accommodation being configured to correspond to the accessory feature upon engagement of the countertop with the countertop-receiving structure.

78. A computer device according to claim 60 wherein the processing portion for processing the data is further configured to add a backsplash component to the countertop representation, the backsplash component being configured to extend generally perpendicularly to the countertop.

79. A computer device according to claim 60 wherein the processing portion for dimensioning a countertop representation is further configured to add at least one of a numerical dimension and a note to the countertop representation.

80. A computer device according to claim 60 further comprising a processing portion for configuring the template to be cooperable with computer-aided design/computer-aided manufacturing (CAD/CAM) computer software.

81. A computer device according to claim 60 further comprising a processing portion for configuring the template to be cooperable with a Computer Numerical Control (CNC) machine.

82. A computer device according to claim 60 further comprising a processing portion for configuring the template to as to be transmittable over an electronic data communication link.
